(19) United States
(12) Patent Application Publication
(10) Pub. No.: US 2011/0047135 A1
(43) Pub. Date: Feb. 24, 2011

(54) MOBILE APPLICATION FOR MONITORING AND REPORTING LAB RESULTS

(76) Inventors: Jeff Vizethann, Cornwall, NY (US); Greg Burks, Albuquerque, NM (US)

Correspondence Address: WILSON, SONSINI, GOODRICH & ROSATI, 650 PAGE MILL ROAD, PALO ALTO, CA, 94304-1050, US

(21) Appl. No.: 12/860,198

(22) Filed: Aug. 20, 2010

Related U.S. Application Data
(60) Provisional application No. 61/235,679, filed on Aug. 20, 2009.

(51) Int. Cl. G06F 17/30

(52) U.S. Cl. 707/705; 707/E17.044

(57) ABSTRACT

The invention provides a mobile application for monitoring and/or reporting laboratory data. The mobile application may be an iPhone application that may provide a user with access to renal, medical, or laboratory data. The mobile application may provide a user with access to a full-sized laboratory data management software application. In some embodiments, the mobile application may share information with the laboratory data management application. The mobile application may include alert categories such as critical results, ICD-9 errors, and reminders.

### CROSS-REFERENCE

This application claims the benefit of U.S. Provisional Application No. 61/235,679, filed Aug. 20, 2009, which application is incorporated herein by reference in its entirety.

### BACKGROUND OF THE INVENTION

Medical laboratory software may be used to monitor and report laboratory results. Some of these laboratory results may be critical and may require a quick or immediate action in response to the results. However, in some instances, a user of the medical laboratory software may not always be accessing or viewing the software in order to get the most up-to-date critical alerts, which may delay an action that needs to occur in response to the alert.

Thus, a need exists for a mobile application that can provide updates to a user of a mobile device, so that even when a user is not at a computer or accessing a full-sized medical laboratory software, the user can receive critical alerts.

### SUMMARY OF THE INVENTION

One aspect of the invention may be directed to a user interface for accessing renal laboratory data. The user interface may comprise a mobile application for accessing a renal laboratory database to provide quick access to renal laboratory data, wherein the mobile application accesses a customized subset of the data stored in the renal laboratory database for individualized purposes. In some embodiments, the mobile application may be stored in a memory on a mobile device.

Another aspect of the invention may be directed to a renal laboratory data access system comprising a mobile device having a memory, wherein the memory includes a mobile application for accessing a renal laboratory database, the mobile application providing alerts relating to renal laboratory data. The renal laboratory data access system may also include a computer having a memory with an additional software for providing access to renal laboratory data, wherein the renal laboratory data is shared with the additional software.

A method for providing renal laboratory data may be provided in accordance with an additional aspect of the invention. The method may comprise displaying, on a video display of a mobile device, a mobile application for accessing a renal laboratory database, thereby providing access to renal laboratory data; and accessing, via the mobile application, a customized subset of data stored in the renal laboratory database for individualized purposes.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE FIGURES

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows one or more client device communicating with a server over a network.

FIG. 2 shows an example of a mobile application and a medical and/or laboratory software program sharing the same data.

FIG. 3 shows an example of an icon on a client device that may provide access to a condensed laboratory application.

FIG. 4 shows an example of a login interface for a condensed laboratory application.

FIG. 5A illustrates a possible user interface display when a user accesses a condensed laboratory application.

FIG. 5B illustrates another example of a possible user interface display when a user accesses a condensed laboratory application.

FIG. 6A shows an example of a user interface displaying critical results of a laboratory reporting application.

FIG. 6B shows another example of a user interface showing a critical results alert report of a laboratory reporting application.

FIG. 7 provides an example of a patient details page of a laboratory reporting application.

FIG. 8 shows an example of a user interface for an errors page of a laboratory reporting application.

FIG. 9 shows an example of a patient error screen of a laboratory reporting application.

FIG. 10 shows an example of a user interface for a reminders list page of a laboratory reporting application.

FIG. 11 shows an example of a reminder details screen of a laboratory reporting application

FIG. 12 shows a bottom of a screen with a navigational section.

### DETAILED DESCRIPTION OF THE INVENTION

While preferred embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides mobile applications for monitoring and reporting laboratory results. Various aspects of the invention described herein may be applied to any of the particular applications set forth below or for any other types of user interfaces and displays, or to renal data management applications. The invention may be applied as a standalone system or method, or as part of an integrated software package, such as a medical and/or laboratory data management package or application. It shall be understood that different aspects of the invention can be appreciated individually, collectively, or in combination with each other.

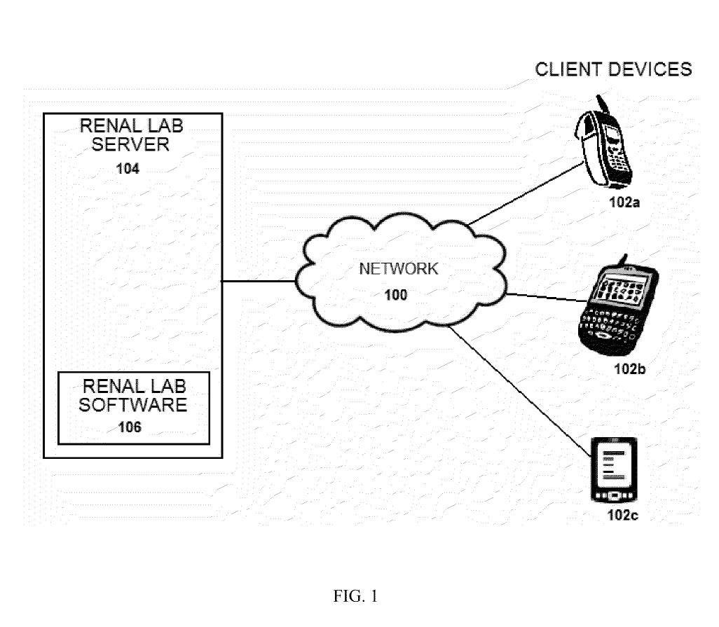

A user interface provided in accordance with the invention herein may be displayed across a network such as the Internet or a wireless communication network. For example, as shown in FIG. 1, an implementation may include a client device 102a, 102b, 102c comprising a video display with at least one display page comprising data. The data may include medical and/or laboratory data, which may include renal laboratory data such as medication and dialysis data (e.g., medication, dialysis, diet, and additional orders, physician electronic signatures, medication labels), visit and treatment logs (e.g., various visit or treatment information, patent assessments, patient notes, access history/usage), and any associated interfacing data (e.g., machine data, or billing data), or so forth. In some preferable embodiments, the data provided may be urgent data that may require immediate or quick actions in response.

Any such medical and/or laboratory data may be provided on any level, such as individual patient level, groups (which may be made up of patients or organized in any other manner), laboratory level, or organization level (e.g., an organization or entity may own or operate one or more laboratories).

Any discussion herein relating to medical, renal, or laboratory data may relate to one another. Thus any discussion of laboratory data may apply to medical or renal data, and vice versa. Similarly, any discussion of any of the aforementioned types of data may relate to any other types of aforementioned data. Furthermore, any discussion herein may also be applied to any other types of data. In some embodiments, such data may be collected from one or more measurement or sensing devices at a clinic or laboratory. Such measurement or sensing devices may collect data from a subject or from a sample obtained from a subject. In some embodiments, data may be entered manually or collected automatically.

Video displays may include devices upon which information may be displayed in a manner perceptible to a user, such as, for example, a computer monitor, cathode ray tube, liquid crystal display, light emitting diode display, touchpad or touchscreen display, and/or other means known in the art for emitting a visually perceptible output. Video displays may be electronically connected to a client device according to hardware and software known in the art.

In one implementation of the invention, a display page may include a computer file 106 residing in memory which may be transmitted from a server 104 over a network 100 to a mobile device 102a, 102b, 102c, which can store it in memory. A mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more client devices across a network, and may transmit computer files residing in memory. The network, for example, can include the Internet, wireless communication network, or any other network for connecting one or more client devices to one or more servers.

Any discussion of a client device or mobile device may also apply to any type of networked device, including but not limited to phones such as cellular phones (e.g., an iPhone, Android, Palm, Blackberry, or any ‘smart phone’) or location-aware portable phones (such as GPS); a personal computer, server computer, or laptop computer; personal digital assistants (PDAs) such as a Palm-based device or Windows CE device; a roaming device, such as a network-connected roaming device; a wireless device such as a wireless email device or other device capable of communicating wireless with a computer network; or any other type of network device that may communicate over a network and handle electronic transactions. Any discussion of any device mentioned may also apply to other devices.

At a client device, the display page may be interpreted by software residing on a memory of the client device, causing the computer file to be displayed on a video display in a manner perceivable by a user. The display pages described herein may be created using a software language known in the art such as, for example, the hypertext mark up language (“HTML”), the dynamic hypertext mark up language (“DHTML”), the extensible hypertext mark up language (“XHTML”), the extensible mark up language (“XML”), or another software language that may be used to create a computer file displayable on a video display in a manner perceivable by a user. Any computer readable media with logic, code, data, instructions, may be used to implement any software or steps or methodology. Where a network comprises the Internet, a display page may comprise a webpage of a type known in the art.

A display page according to the invention may include embedded functions comprising software programs stored on a memory, such as, for example, Cocoa, VBScript routines, JScript routines, JavaScript routines, Java applets, ActiveX components, ASP.NET, AJAX, Flash applets, Silverlight applets, or AIR routines.

A display page may comprise well known features of graphical user interface technology, such as, for example, frames, windows, tabs, scroll bars, buttons, icons, menus, fields, and hyperlinks, and well known features such as a touchscreen interface. Pointing to and touching on a graphical user interface button, icon, menu option, or hyperlink also is known as “selecting” the button, icon, option, or hyperlink. Additionally, a “point and gesture” interface may be utilized, such as a hand-gesture driven interface. Any other interface for interacting with a graphical user interface may be utilized. A display page according to the invention also may incorporate multimedia features.

A user interface may be displayed on a video display and/or display page. A server and/or client device may have access to laboratory data management and/or reporting software. A user interface may be used to display or provide access to medical or laboratory data.

For example, a user interface may be provided for a web page or for an application. An application may be accessed remotely or locally. A user interface may be provided for a mobile application (e.g., iPhone application), gadget, widget, tool, plug-in, or any other type of object, application, or software.

Any of the client or server devices described may have tangible computer readable media with logic, code, or instructions for performing any actions described herein or running any algorithm. The devices with such computer readable media may be specially programmed to perform the actions dictated by the computer readable media. In some embodiments, the devices may be specially programmed to perform one or more tasks relating to renal laboratory data management. In some embodiments, the devices may communicate with or receive data collected from one or more measurement or sensing device, which may collect physiological data from a subject or from a sample collected from a subject.

Mobile Application Architecture

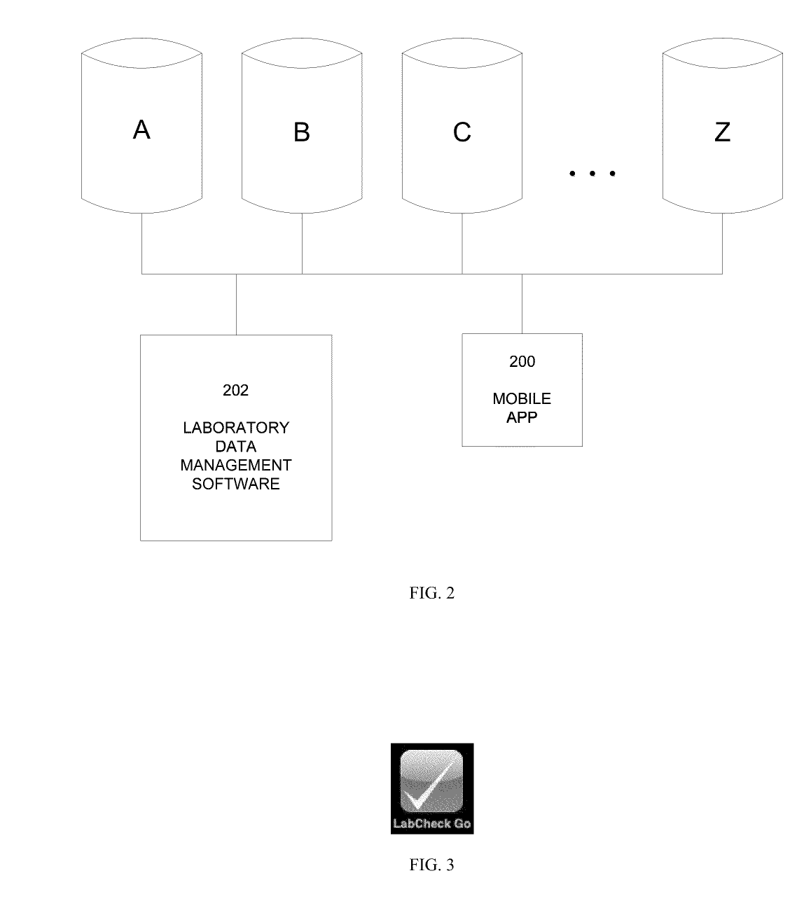

FIG. 2 shows an example of a mobile application 200 and a medical and/or laboratory software program 202 sharing the same data. A mobile application may be a standalone application, or may be part of or otherwise associated with a larger application or software, such as laboratory data management software. The mobile application may communicate with the software program. In some implementations, the mobile application may communicate with a larger laboratory data management software or share data or information with the laboratory data management software. Any discussion of a mobile application herein may apply to any iPhone application, any other ‘smart phone’ application, mobile device application, gadget, widget, tool, plug-in, or any other type of dynamic content, object, application, or software. See e.g., U.S. Pat. No. 5,896,532, which is hereby incorporated by reference in its entirety. A mobile application may be a miniature object that may offer dynamic content that can be placed on any page of the web, phone, or computer desktop environment. The mobile application may be utilized by a roaming device, such as a network-connected roaming device such as a phone, PDA, GPS, or any other mobile device. The mobile application may provide a smaller application (e.g., gadget, widget, tool, object, program) that may not require the complexity, power, or memory of a full-sized laboratory data management application. The mobile application may enable a user to interact with laboratory or medical data, and may provide a graphical user interface for such interaction.

In a preferable embodiment, a laboratory data management software or program may reside on a first system, and a mobile application may reside on a second system. The first system and the second system may be any combination of network devices. For example, the first system may be a server and the second system may be a client device. A server computer may have a software program residing in memory. A client device may have a mobile application residing in local memory. In some instances, the mobile application may have been downloaded to the client device from the server. The mobile application on the client device may communicate with the laboratory data management software program on the server. In some instances, the mobile application may primarily function as a standalone application, but may communicate with the server application in particular situations. In one specific example, the mobile application may be on a mobile device (such as an iPhone, Blackberry, or other ‘smart phone’) and the full-sized software program may be on a computer.

Any communications may occur over a network or directly. Any communication may be via a wired connection or may occur wirelessly.

The mobile application may share data with the software program or another application. For example, the mobile application and the laboratory data management software program may access the same medical, renal, or laboratory data. In some instances, the data may be stored in one or more databases. The data may be stored locally with the laboratory data management software, locally with the mobile application, or may be stored at another system or memory (e.g., a server or client device). The data may or may not be divided and stored on different memories.

In one illustration, as provided in FIG. 2, data may be stored on a plurality of databases (e.g., A, B, C, . . . Z). These databases may be stored anywhere. For example, they may be stored on the same system or on different systems. In one embodiment, a full-scale software program 202, such as a medical, renal or laboratory data software program may be configured to have access to all or most of the data in the databases (e.g., A, B, C, . . . Z). A mobile application 200 may access data in the same set of databases. In some instances, a mobile application may access less data than is accessed by the software program. For example, a mobile application may only access the type of data stored in databases A and B if the data is divided in that manner. Or the mobile application may access bits of data from any of the databases. Depending on the function of the mobile application, the mobile application may only need to access certain types of data. For example, both the software program and the mobile applications may access data relating to critical results, ICD-9 correction requests, and reminders from the same database, but the mobile application may not require information about laboratory trend or goal acquisition information. A mobile application may have a specialized use relating to a particular subset of the data. In some embodiments, the specialized use may include providing alerts relating to a particular subset of data. In some instances, the specialized uses may include providing data relating to critical results, ICD-9 errors, reminders, or other time-sensitive information. The mobile application may or may not be able to access information that is not accessed by the software program.

In any of these situations, the software program and the mobile application may be stored on the same system or on different systems. Similarly, the databases may be stored on the same system or different systems. In some embodiments, the databases may belong to a single organization or may be shared by multiple organizations, clinics, or laboratories. Any components that may be stored on different systems may communicate with one another over a network, including but not limited to a wireless communication network, the Internet, a local area network. In one example, a laboratory data management software program may be stored on a server and may be accessed by a client device, mobile device (e.g., iPhone), or any other type of device. A mobile application may reside on an iPhone, ‘smart phone,’ cellular phone, PDA, or any other type of device, and the databases may be stored on one or more server.

Any form of interaction across one or more systems may be provided, including communication between various applications and/or sharing of data. See e.g., U.S. Patent Publication No. 2007/0208637, U.S. Patent Publication No. 2005/0278202, U.S. Pat. No. 6,094,655, which are hereby incorporated by reference in their entirety.

In some embodiments, the mobile application may take up less memory than the laboratory data management software program. Thus, the mobile application may have a smaller footprint than a corresponding software program. In order to access information in the mobile application, there may or may not be fewer selections or pages a user needs to go through. Similarly, the mobile application may have fewer pages and/or features than the laboratory data management software program. In some instances, the mobile application may require less processing or computing power than the software program. In some instances, the mobile application may operate more quickly than a full scale renal laboratory software program. The mobile application may provide specialized functionality that may be advantageous for providing to a mobile device, such as alerts or notifications that a user may receive while not tied down to a stationary terminal. The mobile application may advantageously provide time sensitive renal laboratory information to a mobile user.

Access to a mobile application may be provided as a pre-existing application along with the laboratory data management software. As discussed previously, a mobile application may be downloaded to a client device. The mobile application may be provided to the client device in any manner known in the art.

In some implementations, a mobile application may be created by any technique known in the art. For example, the mobile application may be created to be compatible with a particular device. For example, the mobile application may be an iPhone application configured to operate on an iPhone device. Thus, the mobile application may operate in an iPhone environment. In some implementations, a mobile application may be a gadget operable to run in an existing environment.

The data provided in the mobile application may be available via a web service to a dedicated secure socket for the mobile application for retrieval and refreshing of data. Connection may be HIPAA compliant. The mobile application may establish an SSL connection (or some other type of secure connection), which may require the user to enter an ID and password. In some embodiments, the user of the application may already access laboratory data management software, and may be entering the same ID and password as provided in the laboratory data management software.

In some embodiments, the laboratory data management software web services may or may not be publically accessible—they may be protected in the application server and made available to the web server hosted by a wireless communication provider (e.g., AT&T, Verizon, etc.). Similarly, the mobile application may or may not be available directly to the public.

Every web service call may be logged. Information may be captured, such as user, IP address, pages viewed, and clicks.

A mobile application may be configured to provide laboratory or medical (e.g., renal, or other medical area) data. A mobile application may be directed to an individual involved in analyzing laboratory or medical data, or providing laboratory or medical data, or otherwise involved with the laboratory, an entity associated with the laboratory, or a patient. Thus, a mobile application may be accessed by a user, who many be anyone involved in laboratory or medical data management or monitoring (e.g., renal data management or monitoring). In some embodiments, a user may have a particular level of access. For example, some users may be critical report readers, who may view critical results. Other users may not be critical report readers, and the critical results section may not be shown to them, or they may not be able to access it. Similarly, for any other utility of a mobile application, a user may be able access some or all of the applications, depending on the user status or access rights.

In some embodiments, a mobile application may be read-only, and will not offer a user the ability to take actions on the content being viewed on the client device. In other embodiments, the mobile application may provide some limited actions in response to the content being viewed. For example, when a user views a critical result, the user may be able to directly call or email an appropriate contact from the client device. Furthermore, a user may be able to correct ICD-9 codes, add or send new reminders, etc. A user may also be able to access a patient results quick lookup feature, for the user to view lab results and analyze graphical trends. Any of the actionable tasks may or may not be provided by the mobile application.

Application Messages

Various important messages may be conveyed before use of the application. These messages can be articulated in an App Description areas of an application store (e.g., App Store and iTunes Store), as well as on a ‘splash screen or ‘info’ screen’ available when the application is launched.
1. “This application is HIPAA compliant.”
2. “Once you read a Critical Report on the iPhone, it will be marked as ‘read’, and it will no longer show up as a Critical Results Alert on the LabCheck web application homepage. Critical Reports will still be available to re-read and print in the Reports/Critical Reports section of the LabCheck web application.”

Any other pertinent messages may be provided in the application description or on the application user interface.

User Interface

FIG. 3 shows an example of an icon on a client device that may provide access to a condensed laboratory application (which may be a mobile application). The condensed laboratory application may allow a user to view Critical Results, ICD-9 Correction Requests, and Reminders on a mobile device, such as an iPhone. The condensed laboratory application may be HIPAA compliant.

In some embodiments, a client device may have one or more icons or other visual indicators that may allow a user to access an application associated with the icon. When a user selects the icon (e.g., by touching a touchscreen, or selecting it using a pointing device, roller ball, arrow keys, or other controller), the user may access the condensed laboratory application.

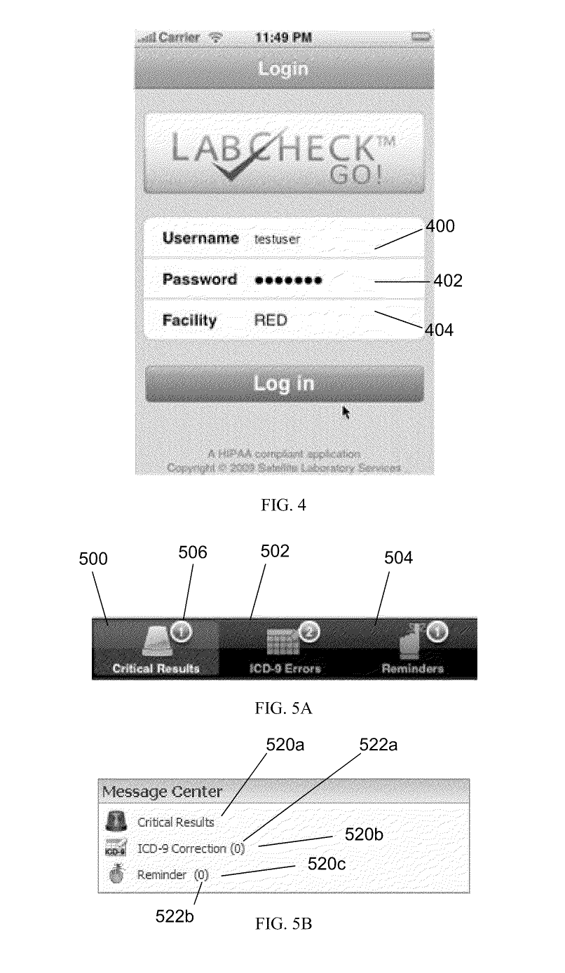

FIG. 4 shows an example of a login interface. After a user has selected an icon to access the condensed laboratory application, the user may view a login interface. In some embodiments, a user may have to enter user identification, such as a username 400. The user may also have to enter a password 402 or other confirmation of the user's identity. In some embodiments, the user may be associated with one or more facility, and may also enter the facility 404 when logging in. Alternate embodiments may not require a login, or may include a login interface with one or more of the features described, or with additional features. A user's identification and password may or may not be shared with a laboratory data management software. The user's identification and password may or may not be associated with the device upon which the mobile application is provided.

FIG. 5A illustrates a possible user interface display when a user accesses the condensed laboratory application. For example, one or more categories of information or alerts may be provided. Some examples of possible alert categories may include: critical results 500, ICD-9 errors 502, and reminders 504. In some embodiments, the data provided by the alert categories may preferably be urgent data requiring quick or immediate action, critical data, any data requiring a response action from the user, or any notifications of errors. Any number of alert categories may be provided. In some embodiments, it may be preferable to keep the number of alert categories low for ease of viewing (e.g., 15 or fewer, 10 or fewer, 8 or fewer, 6 or fewer, 5 or fewer, 4 or fewer, 3 or fewer, or 2 or fewer categories). Each of the alert categories may have a label and/or image associated with the category.

Each category may be displayed in its own region. For example, the critical results may be displayed in a rectangular region, the ICD-9 errors may be displayed in a rectangular region, and the reminders may be displayed in a rectangular region. The various categories may be displayed as a row, column, array, or have any other arrangement.

Furthermore, each category may have an indicator of items to be viewed. Items to be viewed may include any new data from the last time the user had viewed the category. The new item indicator may be any sort of visual indicator that may show that a new item is within the category. In some instances, the new item indicator may also indicate how many items are to be viewed. For example, red circles 506 may be provided when there are new items within a category. A number may be provided within the red circles which may indicate the number of items to be viewed. For example, as shown in FIG. 5A, there may be one critical result to view, 2 ICD-9 errors to view, and 1 reminder to view. The new item indicators may have any shape, color, or size.

The new item indicators may also be visually mapped to the category. For example, the new item indicator may be provided within a region displaying a particular category (e.g., a red circle within a 1 may be within a rectangle for ‘critical results’). The new item indicator may be adjacent to or over an icon or label for an alert category.

In some embodiments, the summary of alert categories may be provided at a particular location on a display. For example, they may be provided at a lower portion of a display, upper portion of display, right or left side of display, or corner of display. In some embodiments, the summary of alert categories may persist as a user views details of alert categories or other pages. For example, a user may select a critical results category and view details about the critical results, while the summary of alert categories is also visible. In some embodiments, a selected alert category, such as critical results, may be highlighted.

FIG. 5B illustrates another example of a possible user interface display when a user accesses the condensed laboratory application. A message center may display the alert categories in a summary format. Each alert category 520a, 520b, 520c may be provided in a list format, and may have a label and/or icon associated with the alert category. The alert categories may also have new item indicators 522a, 522b, which may be visually associated with the alert categories. The new item indicators may indicate if there is a new item to be viewed within the category. The new item indicators may also indicate how many new items are associated with the category.

A user may be able to select an alert category from the message center to view contents in detail. For example, the user may select a critical results category, and ICD-9 errors category, or a reminders category from the message center to view the selected alert category in detail.

Critical Results

For a user defined as a critical report reader, he or she may be notified upon login that new critical values or comments are available in a critical results alert report. Users may select a critical results link to go directly to the critical report (which may be a user interactive screen on the client device, or may be in PDF format, sometimes multiple pages).

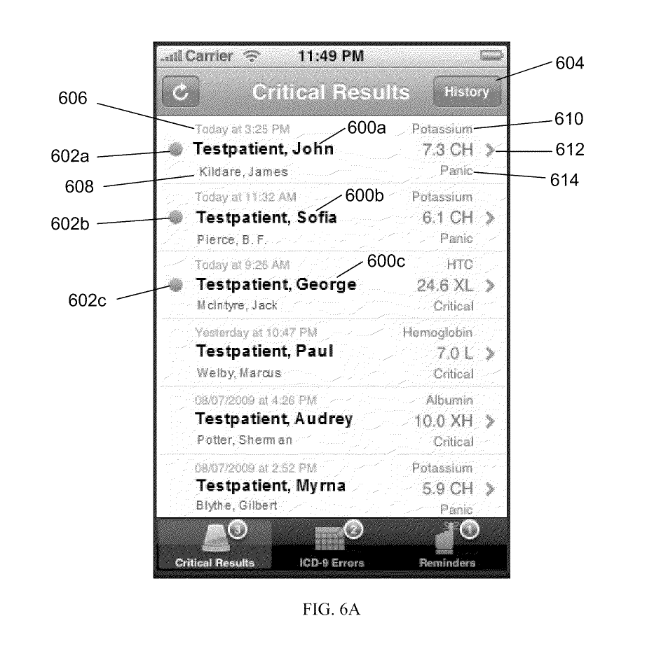

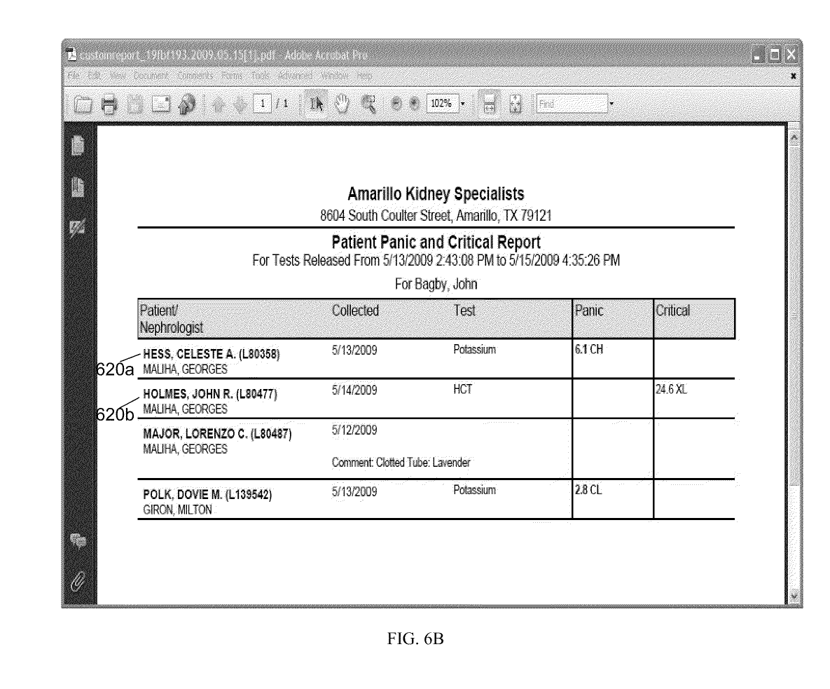

FIG. 6A shows an example of a user interface displaying critical results. If a user of a laboratory reporting application (e.g., mobile application) is a critical report reader, he or she may be notified upon login that new critical values or comments are available in a critical results alert report. The critical results alert report may display various critical results, and may have different features to assist with reading the critical results. The critical results may be displayed as a list of patient names 600a, 600b, 600c. The patient names may be shown as a vertical list, or a horizontal list, or any other visual fashion. The patient names may be ordered chronologically so that the most recent critical results may be displayed first (e.g., at the top of a vertical list). Alternatively, the patient names may be listed alphabetically, or that the most critical or dangerous results are first, or in any other order.

For example, new critical results may be flagged 602a, 602b, 602c. A critical result may be determined to be new if the user has not yet viewed it from the laboratory reporting application. Similarly, a critical result may be determined as new if the user has not acknowledged viewing it. The new critical results may be flagged with any visual indicator. In one example, the new critical results may be flagged with a blue dot on the side.

The critical results alert report may include a feature that may allow a user to access a recent history of acknowledged critical results. For example, this feature may be implemented by a ‘History button’ 604 in the upper right corner (or in another area of the user interface) that the user may select to view the history.

The critical results alert report may show some summary details relating to the patients. For example, for John Testpatient, the time of the alert 606 may be provided. The patient's nephrologist 608 may also be shown. Further, the type of critical result 610 (e.g., Potassium, Hemoglobin, Albumin, etc.) may be shown. The level of the critical result 612 may also be included (e.g., 7.3 CH), as well as the level of criticalness, urgency, or danger 614 associated with the critical result (e.g., Panic, Critical, etc.).

FIG. 6B shows another example of a user interface showing a critical results alert report. An alternate embodiment of the critical results alert report may also include a list of patient names 620a, 620b, as well as summary details about the patient. The summary details may be provided in a chart format, or otherwise be visually associated with the patient, by being in the same row, column, or region as the patient name.

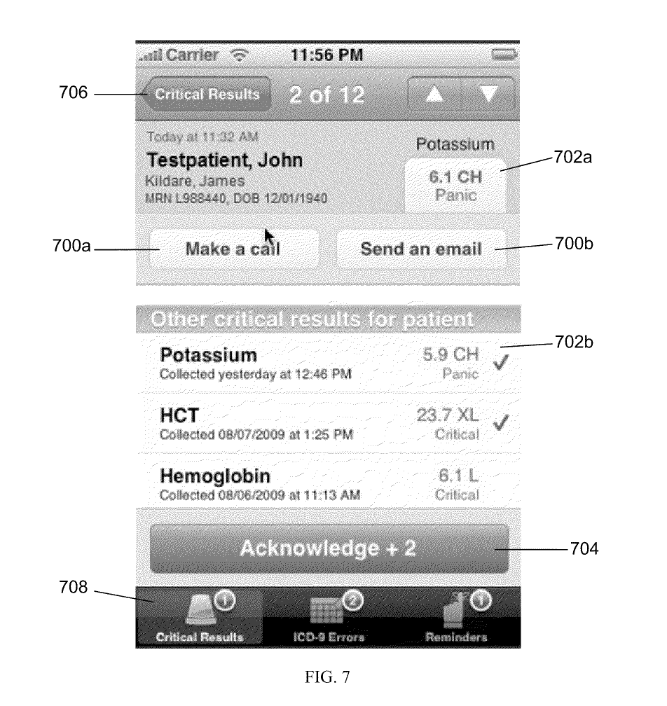

Selecting a patient's name (e.g., clicking on the name, touching the patient's name on a touchpad, or using any other controller to select the patient's name) may allow the latest critical results and/or comments to be displayed on the top part of the screen. In some embodiments, the additional details associated with the patient may be displayed at the top of the screen, on the bottom of the screen, or in any dedicated the section of the screen, which may or may not overlay other parts of the critical results alert report. FIG. 7 provides an example of a patient details page.

From a patient details page, a user may be able to select a button to make a call 700a or send an email 700b. This may provide quick access to allow a user to perform an action in response to the critical result. For example, the user may be able to call a patient's caregiver to alert them of the critical result. In some instances, when making a call, the system may automatically provide the number of the patient's caregiver, or other associated medical individual or entity that may be able to help the patient. For example, selecting an option to make the call may provide a list of individuals from which a user can select the individual to call, or may automatically start calling a primary caregiver for the patient. Similarly, for sending an email, a list of possible email addresses to select from may be provided, or an automatic email may be generated.

The various critical results 702a for a patient may be displayed on the user details page. The various critical results may be displayed at the bottom of the screen, or any other part of the screen. In some instances, a patient may have one or more critical results 702b. If a plurality of critical results exist, they may be provided as a list, chart, or have any other configuration. Critical results may be provided in any order (e.g., most recent, alphabetical, most critical, etc.).

Selecting a critical result and selecting an ‘Acknowledge’ button 704 or other indicator, may indicate that the user has viewed the critical result. The user may acknowledge more than one result at once. For example, each result that the user selects may be marked with a blue check mark or other visual indicator. When prompted, the user may select ‘Acknowledge’ again to confirm. When multiple results are being acknowledged, the ‘Acknowledge’ indicator may display how many results are being acknowledged. For example, if two results are being simultaneously acknowledged, an ‘Acknowledge’ indicator may say something like ‘Acknowledge+2’.

Once a user has read a critical report on the mobile device, it may be marked as ‘read’, and it will no longer show up as a critical results alert on the laboratory data management software application homepage. Similarly, in some embodiments, viewing a critical report through the laboratory data management software may cause the critical report on the mobile application to be marked as ‘read’. Thus, in some instances, a mobile application and a corresponding software may share data with one another. Critical reports may still be available to re-read and print in a Reports/Critical Reports section of the laboratory data management web application.

From a patients details page, to return to a critical results alert report, a user may select a ‘Critical Results’ button 706 or other similar visual indicator on the patients details page. The ‘Critical Results’ button may be in the upper left corner, or any other region of the patients details page. The user may also be able to go right to the next patient on the list, to view the next patient's details, using up and down arrows in the upper right corner, or some other similar visual indicator that may allow the user to navigate directly between patients.

In some embodiments, to access the critical results alert report from another page, a user may select the critical results icon in 708 the lower left corner. The critical results icon and other alert categories may be provided in a navigational bar or section at the bottom of screen, the top of the screen, or any other part of the screen. In some instances, the alert categories may always be visible while the user is accessing the mobile laboratory reporting application.

ICD-9 Code Errors

If there are tests denied by Medicare, a notification is displayed in the Message Center. Users click on an ICD-9 errors link to view a detailed list of the denied tests.

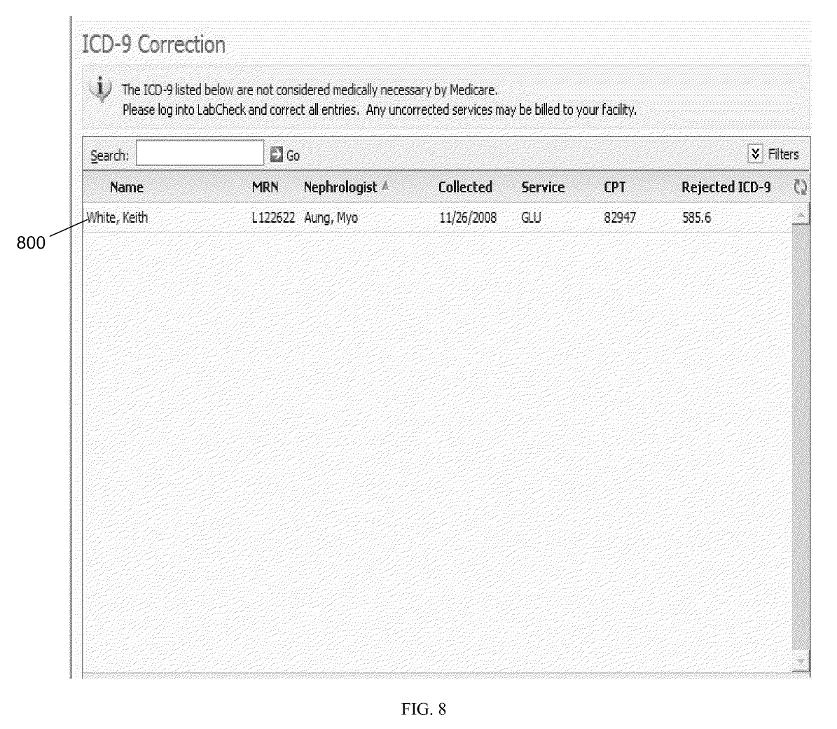

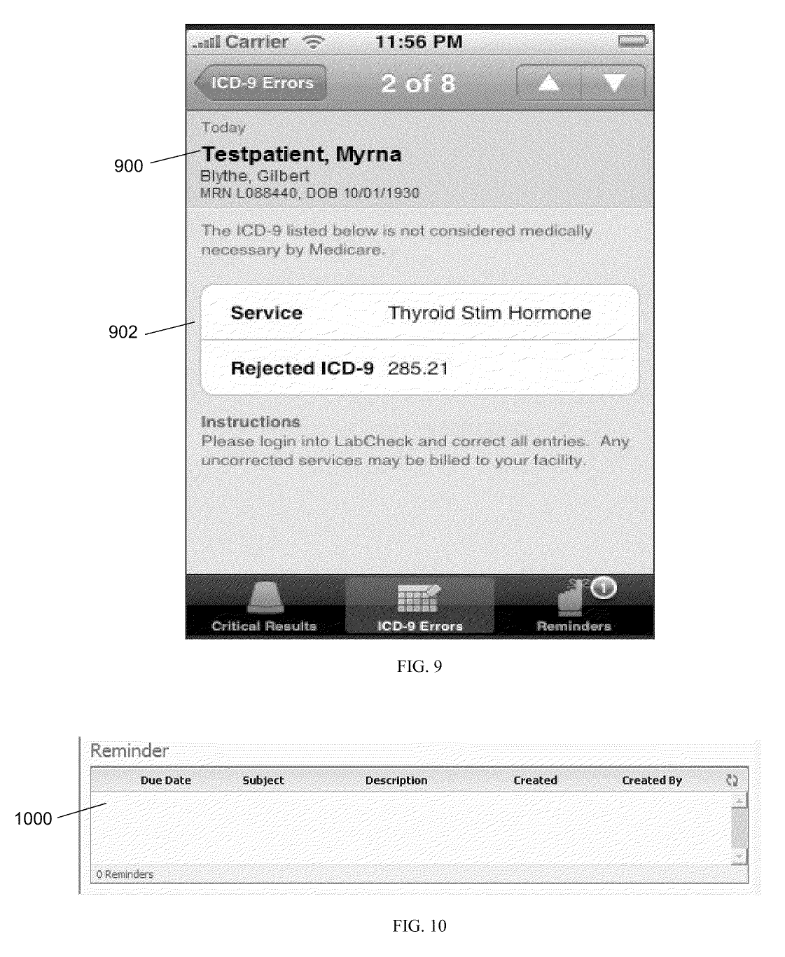

In order to view an ICD-9 errors page, a user may select an ICD-9 errors icon from a navigational section. In some instances, the ICD-9 errors icon may be at the bottom of the screen. In the ICD-9 errors page, the new ICD-9 correction requests may be flagged with a blue dot or any other visual indicator to show a new correction request. FIG. 8 shows an example of a user interface for an errors page, where patients 800 with errors may be listed. However, the errors list page may have any other appearance or user interface, such as one that may have a closer appearance to the critical results page shown in FIG. 6A. The user may click on a patient to view a rejected ICD-9 code and service. FIG. 9 shows an example of a patient error screen which may show patient information 900 as well as details 902 about the error.

The user may take an action following viewing the rejected code. For example, the user may log into the laboratory data management software and correct any errors and entries. This may help any uncorrected services from being billed to the user's facility. In some instances, a user may need to access the laboratory data management software to make corrections, and the mobile application may just inform the user of the error. In some alternate embodiments, the mobile application may also allow the user to make some corrections. In some instances, the mobile application may allow the user to make simple corrections, but may require the user to access the laboratory data management software to make more complex corrections.

To go back to the ICD-9 errors page with the errors list, a user may select an ‘ICD-9Errors’ button on the patient error screen. In one embodiment, the button may be at the upper left corner or any other region of the screen. The user may also go right to the next patient on the errors list, by using up and down arrows in the upper right corner, or any other navigational feature that may allow a user to directly access another patient on the errors list.

Reminders

Users can view personal reminders sent to himself/herself, or by another user in the facility. In order to do so, a user may select a reminders page from a message center.

In order to view a Reminders page, a user may select a ‘Reminders’ icon from a navigational section. In some instances, the reminders icon may be at the bottom of the screen. In the reminders list page, the new reminders may be flagged with a blue dot or any other visual indicator to show a new reminder. FIG. 10 shows an example of a user interface for a reminders list page 1000, where reminders may be listed. However, the reminders list page may have any other appearance or user interface, such as one that may have a closer appearance to the critical results page shown in FIG. 6A. The reminders may be listed according to patient, or reminder type, or have any other organization or order.

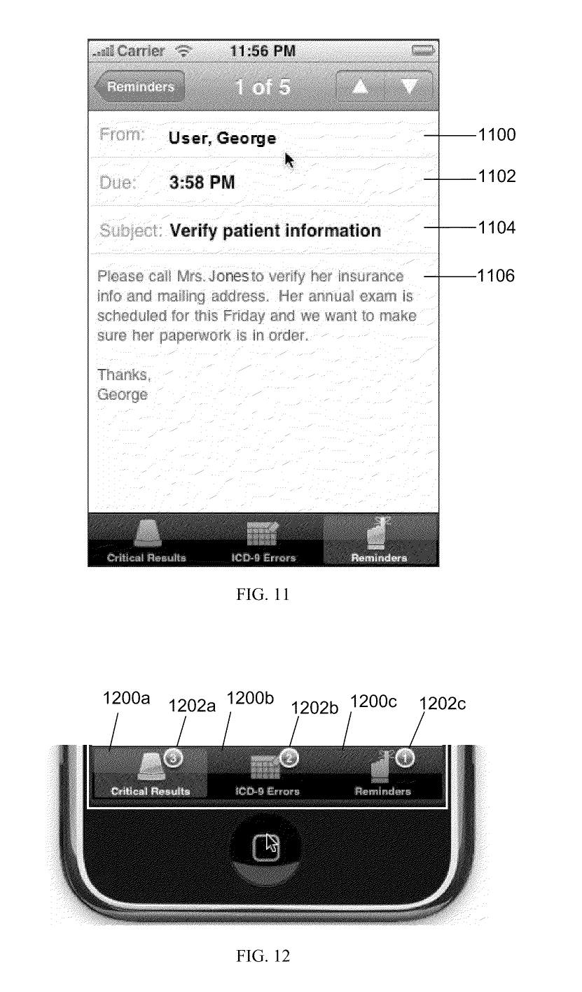

The user may click on a reminder to view the entire reminder message. FIG. 11 shows an example of a reminder details screen which may show specific details about the reminder. For example, the reminder details screen may have who the reminder is from 1100, when an action relating to the reminder is due 1102, a subject 1104, and the detailed reminder message 1106. The reminders may pertain to a patient, medical information (e.g., renal information) associated with the patient, any laboratory data, or any other information where a user of the mobile application may need to take an action or remind another party to take an action.

To go back to the reminders list page, a user may select a ‘Reminders’ button on the reminder details screen. In one embodiment, the button may be at the upper left corner or any other region of the screen. The user may also go right to the next reminder on the reminders list, by using up and down arrows in the upper right corner, or any other navigational feature that may allow a user to directly access another reminder on the reminders list.

Navigation

As previously discussed, a navigational bar or section/menu may be provided which may display and provide access to the various alert categories. For example, the bottom of the screen may display the various alert categories 1200a, 1200b, 1200c and new item indicators 1202a, 1202b, 1202c, as shown in FIG. 12. The navigational section may be displayed regardless of which screen the user is viewing, so that the user may be able to always directly access an alert category list screen from the navigational section.

The navigational section may indicate which alert category the user is currently viewing. For example, as shown in FIG. 6A, a user may be viewing a critical results list page, and the critical results icon may be highlighted and/or colored, or somehow otherwise visually emphasized; in FIG. 9 a user may be viewing an ICD-9 errors list page, and the ICD-9 errors icon may be highlighted and/or colored, or somehow otherwise visually emphasized; in FIG. 11 a user may be viewing a reminders list page, and the reminders icon may be highlighted and/or colored, or somehow otherwise visually emphasized. Similarly, when a user is viewing a details page for a particular alert category, the corresponding alert category in the navigational section may be visually emphasized.

In order to log out of a mobile laboratory reporting application on the client device, a user may press a home button to log out. For example, as shown in FIG. 12, a pointer is over the home button, which would be hit to log out of the mobile application.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A user interface for accessing renal laboratory data comprising:
a mobile application for accessing a renal laboratory database to provide quick access to renal laboratory data,
wherein the mobile application accesses a customized subset of the data stored in the renal laboratory database for individualized purposes.

2. The user interface of claim 1, wherein the mobile application is stored in a memory on a mobile device.

3. The user interface of claim 2, wherein the mobile device is at least one of the following: a cellular phone, a smartphone, a laptop computer, or a personal digital assistant.

4. The user interface of claim 1, wherein the mobile application includes a critical results list page.

5. The user interface of claim 4, wherein the critical results lists page includes a list of patients that are ordered chronologically, by patient name, or by level of danger to the patient.

6. The user interface of claim 1, wherein the mobile application includes a ICD-9 errors page.

7. The user interface of claim 6, wherein the ICD-9 errors page provides access to a patient error screen which shows additional details about a selected patient and error.

8. The user interface of claim 1, wherein the mobile application includes a reminders list page.

9. The user interface of claim 1, wherein the data stored in the renal laboratory database is also accessed by a full-sized laboratory data management software application.

10. The user interface of claim 9, wherein the full-sized laboratory data management software application is stored in memory on a computer.

11. A renal laboratory data access system comprising:
a mobile device having a memory, wherein the memory includes a mobile application for accessing a renal laboratory database, the mobile application providing alerts relating to renal laboratory data.

12. The renal laboratory data access system of claim 11, further comprising a computer having a memory with an additional software for providing access to renal laboratory data, wherein the renal laboratory data is shared with the additional software.

13. The renal laboratory data access system of claim 12, wherein the mobile application accesses a subset of the information stored in memory that may be accessed by the additional software.

14. The renal laboratory data access system of claim 11 wherein the mobile device is selected from the following: a cellular phone, a smartphone, a laptop computer, or a personal digital assistant.

15. The renal laboratory data access system of claim 11 wherein the alerts are provided for at least one of the following categories: critical results, ICD-9 errors, or reminders.

16. A method for providing renal laboratory data comprising:
displaying, on a video display of a mobile device, a mobile application for accessing a renal laboratory database, thereby providing access to renal laboratory data; and
accessing, via the mobile application, a customized subset of data stored in the renal laboratory database for individualized purposes.

17. The method of claim 16, wherein the mobile application displays one or more alert category.

18. The method of claim 17, wherein the one or more alert category shows an indicator of the number of new alerts associated with the alert category.

19. The method of claim 17, wherein the alert categories are displayed along with additional details about a selected alert category.

20. The method of claim 16, further comprising:
accessing, via a full-sized software application, the data stored in the renal laboratory database.

21. The method of claim 20, wherein the mobile application is stored on a mobile device and the full-sized application is provided on a computer.
